(19) United States
(12) Patent Application Publication
(10) Pub. No.: US 2024/0220994 A1
(43) Pub. Date: Jul. 4, 2024

(54) PROVIDING APPLICATION NOTIFICATION FOR COMPUTING APPLICATION LIMITATIONS

(71) Applicant: PAYPAL, INC., San Jose, CA (US)

(72) Inventors: Hans Raj Verma, Tokyo (JP); Russell Frank Cummer, Tokyo (JP)

(21) Appl. No.: 18/148,956

(22) Filed: Dec. 30, 2022

(51) Int. Cl. G06Q 20/40

(52) U.S. Cl. CPC G06Q 20/405

(57) ABSTRACT

There are provided systems and methods for providing application notifications for computing application limitations. A user may engage in a transaction with another user, such as a purchase of goods, services, or other items a merchant using a payment account and/or payment card, such as through a software application. An online transaction processor may provide a monitoring operation to enforce an electronic transaction processing limit on use of one or more account and/or payment limitations via the application. This limit may correspond to a processing limit or throttle, which may limit use of a spending limit in the application below a maximum amount of usage allowed. When the limit is utilized, the online transaction processor may determine that the throttle is approved or violated and may allow a user to configure such limitation through slidable and/or adjustable application icons and interfaces.

### TECHNICAL FIELD

The present application generally relates to data processing and more particularly to providing one or more selectable interface throttles or options for providing application limitations in a computing application.

### BACKGROUND

Users may utilize online transaction processors for processing payments between different entities through device applications and digital accounts. Further, these online transaction processors may also provide payment options, loans, and/or extensions for in-person transaction processing and use at merchant locations. When extending payment options and spending limits via one or more software applications, users may receive a credit limit and/or may be capable of utilizing a credit balance, real funds, or virtual funds linked to a digital account. While users may desire to have additional credit (e.g., to enable more purchasing power or improve a credit rating of the user), the user may not want to have the entire limit available based on personal decisions Moreover, since the account is utilized the user and not a computing device, such as a mobile phone, the user may not be capable of viewing an available or statement balance for a periodic cycle, a credit limit or amount of used credit, and/or other available funds. Thus, the online transaction processor may want to enforce preemptive and/or adjustable limitations on the account. Thus, with the increasing threat of cyber-attacks, phishing schemes, and malware that may compromise the user's or digital account, the user and online transaction processor may desire to enforce preemptive, adjustable, and/or real-time limits on account usage to reduce fund exposure to the account.

### BRIEF DESCRIPTION OF THE DRAWINGS

FIG. 1 is a block diagram of a networked system suitable for implementing the processes described herein, according to an embodiment;

FIGS. 2A-C are exemplary diagrams for establishing and adjusting a spending and/or electronic transaction processing limit on a digital account with an online transaction processor, according to an embodiment;

FIG. 3 is an exemplary system environment of interactions between system components for generating and dynamically adjusting application limitations to enforce account usage limitations, according to an embodiment;

FIG. 4A is a flowchart of an exemplary process for generating application limitations to enforce account usage limitations, according to an embodiment;

FIG. 4B is a flowchart of an exemplary process for dynamically adjusting application limitations to enforce account usage limitations, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for processing throttles to enforce account usage limitations. Systems suitable for practicing methods of the present disclosure are also provided.

A user may utilize a digital account, payment card, and/or other funding source to process payments through an electronic card or a transaction network associated with a backend payment processor or other entity on the network. An identifier may be linked to a digital account of the user with an online transaction processor, such as a payment service provider (e.g., PayPal®), which may provide electronic transaction processing services to users through the account and one or more websites and/or applications of the online transaction processor or a merchant. The digital account may be established with a credit limit and/or may have a balance or value available for use with the digital account. The online transaction processor may include an integration with the electronic card network that allows for data exchange and communications between the two networks. The user and/or the online transaction processor may establish one or more spending or transaction processing limits on the digital account and/or available spending limits and balances, such as for use of the credit limit and/or balance, which may include different configurable levels or parameters. For example, a transaction processing limit and/or spending limit may limit available credit to the digital account to less than a maximum amount of credit, such as $3,000 even though the maximum credit limit is $10,000. Thereafter, the online transaction processor may monitor the digital account and/or digital accounts usage on an electronic card network to enforce the spending limit and limit card usage. This data processing may occur in certain time intervals or after a time period or cycle, such as weekly, monthly, or the like (e.g., after a billing cycle). Further, users may be able to utilize a software application to adjust such limits, such as by accepting a maximum extendible limit and/or throttling or moving the limit to a lower level. Thereafter, as the user utilizes the digital account to process transactions, the online transaction processor may prevent data processing if a level, threshold, or extendable balance is exceeded. Additionally, the online transaction processor may alert the user if such configurable balance is exceeded and provide an option to remove a lower-level balance, adjust the balance, and/or approve the transaction based on available and/or extendable credit balances.

In this regard, a user may process a purchase of the items via a software application and/or digital account that provides values, credit, or other funds to the user through an online transaction processor and/or electronic card network. Selection of one or more items in an in-person transaction at a physical merchant location or via an online marketplace or other digital platform may require a payment instrument from the user for electronic transaction processing. A user may pay for one or more transactions using a digital wallet or other account with an online service provider or other transaction processor (e.g., PayPal®), as well as the digital account (e.g., through proffering the card and having the card data read or by entering card details and/or account numbers). An account and/or corresponding digital account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including digital account (e.g., credit/debit card) information, bank account information, gift card information, benefits/incentives, and/or financial investments, when processing transactions with merchants and/or other users or entities. Account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. The digital account linked to the user may also correspond to a peer-to-peer payment account and/or social networking account, such as one that may be used on a peer-to-peer payment and social networking platform provided by the online transaction processor. Moreover, the digital account may be utilized through one or more mobile applications for mobile devices or other software applications.

In order to pay for the transaction (e.g., a transfer or payment to another user, merchant, or other entity), the user may provide the digital account or funding source information or may login to an account with the service provider through authentication information in a software application. A payment may then be issued to the other party to the transaction and transaction information may be stored with the digital wallet or account. In this regard, a digital token or other data may authorize and/or authenticate the user for their digital wallet use and/or a payment instrument in the digital wallet, which may be transmitted to another party (e.g., the agent and/or merchant) for payment processing. The data may be stored to one or more storage mediums on the digital account, such as a magnetic stripe or an EMV chip. For example, a POS device and/or card reader may be used to read the card data from a merchant device at a merchant location. This may allow for user payments through a payment account and/or digital wallet. In some embodiments, the account and/or digital wallet may be linked to the user's device or application and a checkout process may be authorized by the user, where selection of the account or other data may automatically initiate the process to purchase the item using the account and/or digital wallet.

Once the digital account is opened, such as after a credit and/or debit card is opened, established, and/or linked to the user's digital account, the user may receive an available balance that may be utilized by the user. This may correspond to a real or virtual asset or value and may be a revolving credit limit extended to the user. The user may desire to enforce limitations on electronic transaction processing and spending of the available balance, such as the revolving credit limit. For example, a high maximum credit limit may be extended to the user (e.g., $5,000, $10,000, $30,000), however, the high maximum credit limit that was extended would negatively affect the user's budget if the user were to spend up to this limit. In this regard, the user's budget may only be able to afford $2,000 of credit repayments or balance payments (e.g., a payoff of the extended credit's balance) in a revolving credit billing cycle or time period, whether temporary or recurring. Thus, the user may establish a lower limit that prevents electronic transaction processing using the digital account and/or digital account.

In this regard, the user may utilize a mobile and/or resident software application on a computing device and/or a website to receive and/or view one or more spending limits and/or transaction processing limits with the digital account and/or digital accounts credit limit. These interfaces may allow the user to view a maximum spending limit that may be extended based on one or more rules, regulations, and/or budgets that are associated with the user. For example, governmental and/or regulatory laws or rules may set an available limit for a user. Further, the user's budget, income, past repayment data, credit rating, or other user data may set those limits. Those limits may further be determined using a rules-based and/or machine learning (ML)-based artificial intelligence (AI) engines that may precompute and recompute such limits based on real-time and/or available user data. Such AI engines may also use merchant data, merchant agreements, and other data to compute such limits. Once computed, the limits may be transmitted to a user device of the user so that such data is available and viewable through one or more user interfaces.

Thereafter, the user may set the spending limit at and/or below the maximum credit limit extended to the user. For example, where a maximum credit limit is $10,000, the user may set a spending limit at any level between $1-$10,000. The user may set the spending limit at a level that corresponds to the user's budget during a specific time period or a recurring period, and/or a budget may be recommended to the user. The spending limit may correspond to an electronic transaction processing limit that prevents use of extended credit or other balance using the digital account when performing electronic transaction processing through the application and/or using another payment instrument. Thus, if the spending limit or other established threshold on credit usage of the extended credit is met or exceeded, the online transaction processor may prevent processing, such as by declining the transaction and/or instructing the backend credit processor system and electronic card network to decline the transaction and prevent transaction processing and use of the credit limit.

The user may set different spending limits, such as through a budget setting tool, and/or limits of electronic transaction processing using the balance of extended credit or other value through the digital account and/or digital account. The budget setting tool may be attached to a total risk exposure limit, such as a maximum credit limit, that may be provided by the online transaction processor to a user. The spending limit available through the budget setting tool may also be configurable and/or computed using an engine of such a service provider, and may be static, such as for monthly spending limits, or dynamic, such as based on a budget available to a user over a time period. However, the budget setting tool that is tied to the total risk exposure limit is separate from a monthly power or monthly available funds that is decided by the online transaction processor's risk team and risk analysis operations. This monthly power may be based on the user's risk profile, payment availability check constraints, and the like, where constraints may be based on local or regional law, regulations, and/or compliance requirements.

For example, the spending limit may be a static amount, such as the $2,000 limit that prevents the user from exceeding that limit that may be configurable by the user in a user interface between a minimum and maximum amount available to the user. This may not reset after a time period or may do so based on the user's income, budget, or other preferences and data. The spending limit may also be for a dynamic or variable limit, such as $2,000 in a month and may therefore reset after the time limit and/or based on spending. Additionally, other data may also be used to set different types of spending limits, for example, based on merchant agreements, merchant category codes (MCCs) and transactions categories, a time of day, a purchase type, and the like. Where the spending limit limits a particular type of transaction processing and/or is a dynamic or variable limit, the spending limit may be for a time period, such as a payment and/or billing cycle, and may reset after the time period. Additionally, the spending limit may be particular to one digital account from a plurality of accounts and/or limits extended to the user. Additionally, the spending limit may be tiered and may release additional credit or other funds and value progressively, such as when each spending limit is reached, during different days or months, and the like. Thus, the user may utilize one or more user interfaces to configure and/or adjust the spending limit, such as through a slidable or scrollable bar, icon, or the like.

Thereafter, a transaction may be processed using the digital account(s), which may generate and process transaction data for the transaction on a digital network. The transaction data may further include information, such as one or more items, item costs (e.g., itemizations) and/or a total cost, a transaction time, a corresponding merchant or merchant identifier, other users involved in the transaction, a transaction location, an MCC identifying a particular category for each transaction, and/or other transaction data. The online transaction processor may provide electronic transaction processing services used to process the transaction using the transaction data and/or card data. However, in other embodiments, in order to receive this data, the online transaction processor may be required to interface with a backend card processor and/or electronic card or transaction network that transmits, receives, and/or processes the transaction data based on associated payment instrument data, such as a payment card, bank account, or the like. In this regard, the online transaction processor may utilize an application programming interface (API) to communicate and integrate with one or more APIs of the electronic card network. This allows the online transaction processor to detect, receive, and process the transaction data, for example, by setting and/or enforcing spending limits on transactions that are processed on the electronic payment network. Thereafter, the transaction data may be detected and/or transmitted to the online transaction processor via one or more APIs. This may include receiving and processing the data in real-time, such as when the transactions occur in order to enforce spending limits and other electronic transaction processing limits on the digital account when used for electronic transaction processing on one or more networks.

When the transaction data for a transaction is received by the online transaction processor when the transaction is requested to be processed, the transaction data may then be analyzed to determine whether the transaction complies with or violates the limit(s) established in the application for the account. This may be done by listening to card reading and/or scanning events and receiving corresponding transaction information, or by monitoring incoming communications from the electronic card network, merchants, point-of-sale (POS) devices, and the like, as well as identifying electronic transaction payments requested through a digital account. Additionally, the online transaction processor may provide a card product that utilize a physical payment card, such as a card with a magnetic strip, EMV chip, NFC or RFID transceiver, or the like, to convey information. This may allow a user to unlock future monthly power at checkout at a merchant location, such as a cash register or POS device in real-world stores and locations. The user may therefore select and/or change a next month due at a POS device using the physical card.

If the transaction complies with the limit, then the online transaction processor may approve the transaction or allow the transaction to be approved on the electronic card network (e.g., by not declining the transaction or requesting the electronic card network and/or backend credit card processing system to decline the transaction). However, if the transaction violates the limit or otherwise does not comply with the limit (e.g., if the transaction amount causes the balance of the digital account and/or digital account to exceed the limit balance cap), then the online transaction processor may decline the transaction by refusing to process the transaction and/or requesting that the electronic card network and/or backed credit card processing system reject or decline the transaction.

If the transaction exceeds or violates the limit, the online transaction processor may refuse processing of the transaction and/or transmit a message having a notification or alert to a device of the user. The device may include an application having one or more interface options, elements, or graphics that may include an executable option, operation, and/or selectable element to remove or adjust the spending limit so that the transaction may be processed. This may include a slidable adjustment that allows configuration of a spending limit between different available transaction and/or credit limits. Such limits may be extendable based on various merchant agreements and/or regulatory guidelines, and may also be set at one or more levels by the AI engine of the service provider. The notification or alert may be transmitted through text message, such as SMS or MMS, or through another messaging system and protocol, such as instant message, application push notification for a mobile application, email, website chat interface, or the like. The user may also be provided the option to access the user's digital account and change the spending limits, for example, by authenticating the user through an application or website and viewing one or more spending limits with selectable interface options and/or interface fields for input of data to adjust the spending limits. Thereafter, the online transaction processor may update the spending limit and continue to monitor the digital account and/or digital account usage for compliance with the updated spending limit.

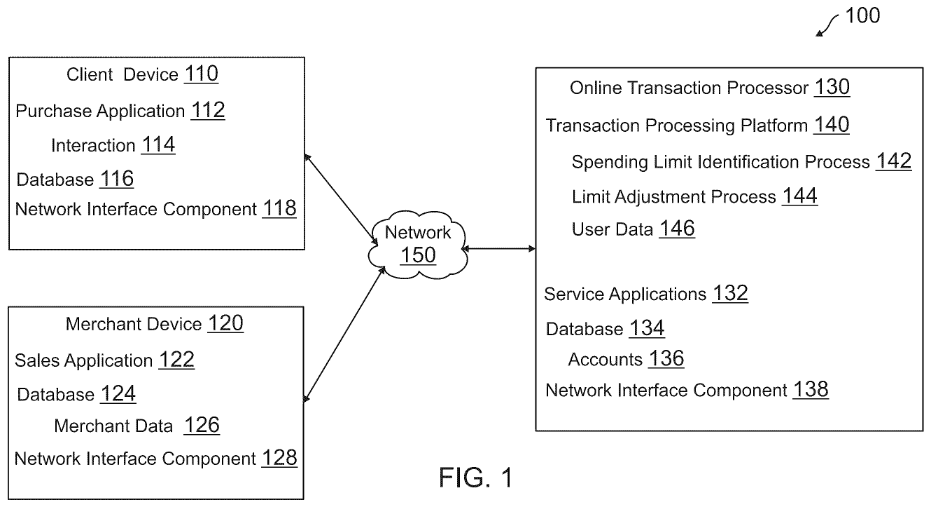

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a client device 110, a merchant device 120, and an online transaction processor 130 in communication over a network 150. Client device 110 may be used to establish a transaction and process a payment for the transaction using an account managed by client device 110. In this regard, when the transaction is processed, the transaction data may be provided over a transaction network, which may be available over network 150. Client device 110 and merchant device 120 may be used to set spending limits or other electronic transaction processing limits on use of a balance, such as an amount of a maximum extended credit limit. Online transaction processor 130 may then be used to detect the transaction data and determine whether the transaction data complies with the spending limit.

Client device 110, merchant device 120, and online transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented using any appropriate hardware and software configured for wired and/or wireless communication with merchant device 120 and/or online transaction processor 130 for processing a transaction based on one or more spending limitations. Client device 110 may correspond to a user that processes payments and sales through an executable software application. In various embodiments, client device 110 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing device may function similarly.

Client device 110 of FIG. 1 contains a purchase application 112, a database 116, and a network interface component 118. Purchase application 112 may correspond to executable processes, procedures, and/or applications with associated hardware. In other embodiments, client device 110 may include additional or different modules having specialized hardware and/or software as required.

Purchase application 112 may correspond to one or more processes to execute software modules and associated components of client device 110 to provide features, services, and other operations for a user over network 150, which may include accessing and utilizing computing services provided by online transaction processor 130. In this regard, purchase application 112 may correspond to specialized software utilized by a user of client device 110 that may be used to access a website or application (e.g., mobile application, rich Internet application, or resident software application) that may display one or more user interfaces that allow for interaction with the computing services of online transaction processor 130. In various embodiments, purchase application 112 may correspond to a general browser application configured to retrieve, present, and communicate information over the Internet (e.g., utilize resources on the World Wide Web) or a private network. For example, purchase application 112 may provide a web browser, which may send and receive information over network 150, including retrieving website information, presenting the website information to the user, and/or communicating information to the website. However, in other embodiments, purchase application 112 may include a dedicated application of online transaction processor 130 or other entity.

Purchase application 112 may be associated with account information, user financial information, and/or transaction histories. However, in further embodiments, different services may also be provided via purchase application 112, including social networking, media posting or sharing, microblogging, data browsing and searching, online shopping, and other services available through online transaction processor 130. Thus, purchase application 112 may also correspond to different service applications and the like. When utilizing purchase application 112 with online transaction processor 130, purchase application 112 may request processing of an interaction 114, such as a payment request and/or spending limit request or adjustment with online transaction processor 130. Interaction 114 may correspond to utilizing purchase application 112 to request, establish, and/or adjust a spending limitation via one or more application icons, interfaces, and/or interactions with such displayable data. Interaction 114 may also include a payment request with one or more merchants, which may individually be merchant specific for a spending limit or may be for a spending limit available over multiple merchants. Interaction 114 may be used with a user account of the user, and interaction 114 may have a corresponding user input for the spending limit.

In various embodiments, client device 110 includes other applications as may be desired in particular embodiments to provide features to client device 110. For example, the other applications may include security applications for implementing client-side security features, programmatic client applications for interfacing with appropriate application programming interfaces (APIs) over network 150, or other types of applications. The other applications may also include email, texting, voice and IM applications that allow a user to send and receive emails, calls, texts, and other notifications through network 150. In various embodiments, the other applications may include financial applications, such as banking applications. Other applications may include social networking applications, media viewing, and/or merchant applications.

The other applications may also include other location detection applications, which may be used to determine a location for the user, such as a mapping, compass, and/or GPS application, which can include a specialized GPS receiver that determines location information for client device 110. The other applications may include device interface applications and other display modules that may receive input from the user and/or output information to the user. For example, the other applications may contain software programs, executable by a processor, including a graphical user interface (GUI) configured to provide an interface to the user. The other applications may therefore use devices of client device 110, such as display devices capable of displaying information to users and other output devices, including speakers.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with purchase application 112 and/or the other applications, identifiers associated with hardware of client device 110, or other appropriate identifiers, such as identifiers used for payment/user/device authentication or identification, which may be communicated as identifying the user/client device 110 to online transaction processor 130. Moreover, database 116 may include data used for interaction 114, such as data that may be provided as a data load processed by online transaction processor 130.

Client device 110 includes at least one network interface component 118 adapted to communicate with online transaction processor 130 and/or other devices and servers over network 150. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant device 120 may be maintained, for example, by a merchant or other entity that provides items for sale to users. Merchant device 120 may correspond to one or more physical and/or online merchant marketplaces, sales platforms, point-of-sale (POS) devices, websites, and/or online resources where a user may visit in order to shop for items. For example, merchant device 120 may correspond to one or more POS devices at physical merchant locations to process transactions, as well as websites and/or applications accessible digital platforms, where a user may offer or be offered products, services, and other items for sale and users may browse items, select items for purchase, and engage in electronic transaction processing. Merchant device 120 may further include other platforms, websites, and resources that may allow users to engage in electronic transaction processing, such as those associated with payment processors, transfers of funds, payment of utilities or living expenses, and other payments or purchases that may be used by users and may require payment of a balance due for some product, service, or other item. In some embodiments, merchant device 120 may be implemented as a single or networked personal computers (PCs), servers, a smart phone, laptop computer, wearable computing device, and/or other types of computing devices. Although only one merchant device is shown, a plurality of merchant devices may function similarly.

Merchant device 120 of FIG. 1 contains a sales application 122, a database 124, and a network interface component 128. Sales application 122 may correspond to executable processes, procedures, and/or applications with associated hardware. In other embodiments, merchant device 120 may include additional or different software as required.

Sales application 122 may provide and/or process items for sale with client device 110 and/or a user associated with client device 110 (e.g., payment sources including a payment card, digital account, cash, etc.). In certain embodiments, sales application 122 may be accessible over the Internet and provide for sales with client device 110 over network 150. Sales application 122 may also correspond to a checkout application at a physical merchant location, such as the application(s) of a point-of-sale (POS) device used to provide sales at physical locations. Sales application 122 may be used to establish a transaction once a user/employee associated with merchant device 120 has entered one or more items for purchase and/or entered the item(s) to the transaction for processing. Once a payment amount is determined for the item(s) to be purchased by the user, merchant device 120 may request payment for the transaction. Payment may be provided using a digital account, however, merchant device 120 and/or the merchant corresponding to merchant device 120 may have a corresponding agreement with the user of client device 110, the service provider of online transaction processor 130, and/or a regulatory service or agency. In this regard, payment may be received from a digital account based on a spending limit established by an AI engine of online transaction processor 130 and/or set through client device 110. After receipt of payment by a digital account and/or confirmation of a digital account transfer, merchant device 120 may then process a payment to the merchant associated with merchant device 120 using the digital payment.

Merchant device 120 may further include database 124 which may include, for example, identifiers associated with sales application 122 and/or other applications, identifiers associated with hardware of merchant device 120, or other appropriate identifiers. Database 124 may receive and store data from client device 110, such as in response to receiving transaction data and/or payment data. Database 124 may therefore further store, use, and/or access a digital account and/or digital account exchanges, such as those that may include information associated with merchant data 126, which may be used when determining and dynamically adjusting spending limits in user interfaces of client device 110.

Merchant device 120 includes at least one network interface component 128 adapted to communicate with client device 110, online transaction processor 130, and/or other devices or servers over network 150. In various embodiments, network interface component 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Online transaction processor 130 may be maintained, for example, by an online service provider, which may provide processes to provide account services and process payments, as well as establish spending limits on a digital account's usage of a balance or credit limit associated with the spending limits. In this regard, online transaction processor 130 includes one or more processing applications which may be configured to interact with client device 110, merchant device 120, and/or another device/server to facilitate communications and transactions between users. Online transaction processor 130 may be maintained by or include another type of platform or service provider, for example, a transaction processor such as PAYPAL®, Inc. of San Jose, CA, USA. Although merchant device 120 and online transaction processor 130 are discussed as separate devices and servers, in some embodiments, one or more of the described processes of may instead be provided by the other device or server, or the same device or server.

Online transaction processor 130 of FIG. 1 includes a transaction processing platform 140, service applications 132, a database 134, and a network interface component 138. Transaction processing platform 140 and service applications 132 may correspond to executable processes, procedures, and/or applications with associated hardware. In other embodiments, online transaction processor 130 may include additional or different modules having specialized hardware and/or software as required.

Transaction processing platform 140 may correspond to one or more processes to execute modules and associated specialized hardware of online transaction processor 130 to process a transaction for item(s) with client device 110 and merchant device 120, which may be based on one or more transactions and spending limitations established with the user of client device 110. In this regard, transaction processing platform 140 may correspond to specialized hardware and/or software used by a user associated with client device 110 to establish an account with transaction processing platform 140 by providing personal and/or financial information to online transaction processor 130 and selecting authentication credentials. In various embodiments, the financial information may include payment instrument information, such as account/card numbers and information. The account may be used to purchase items and/or transfer funds. The payment account may be accessed and/or used through a browser application and/or dedicated payment application. However, in other embodiments, a payment account may be generated by another online transaction processor or service provider and linked with online transaction processor 130, such as through merchant device 120. Transaction processing platform 140 may be used to set spending limits on usage of a balance, credit limit, or other funds for a digital payment account. Transaction processing platform 140 may process a payment and may provide a transaction history for transaction authorization, approval, or denial,

Transaction processing platform 140 may correspond to a product of online transaction processor 130 that may be utilized by end users, such as to perform electronic payments, transfers, and the like using one or more accounts and/or financial instruments. Transaction processing platform 140 may also include or utilize different processors, engines, or models as required for an authentication, account setup and maintenance, electronic transaction processing, deposit and/or withdrawal, dispute resolution, and the like. Transaction processing platform 140 may include one or more API integrations and/or interactions with an electronic card network or other payment network in order to detect, receive, and monitor transaction data for compliance with spending limits and/or adjustable and dynamic settings on such limits on use of one or more balances for a digital account of a user. Thus, transaction processing platform 140 may interact with the network through one or more API calls to APIs of transaction processing platform 140 that interfaces with APIs of the electronic card network. Transaction processing platform 140 may determine transaction data for transactions processed on the network.

Transaction processing platform 140 may receive the transaction data for transactions processed using the account accessible through client device 110 and/or merchant device 120. Transaction processing platform 140 may then determine spending limits set on usage of a balance, credit limit, and/or other funds available to the digital account of the user. In this regard, an AI engine of transaction processing platform executed by a spending limit identification process 142 may be utilized with a limit identification process 144 with user data 146 and merchant data 126 to calculate spending limits based on user budgets and/or merchant agreements, as well as allow for users to configure such limits through an application interface of purchase application 112 or the like. For example, the spending limits may be established at and/or lower than a maximum balance amount or maximum extended credit limit based on the determination of the credit limit by spending limit identification process 142. The spending limit may therefore adjust or lower the available credit limit or other balance below the maximum amount (e.g., where a spending limit may be for $1,000 of a $5,000 limit). Thereafter, using the API calls with the electronic card network, devices (e.g., client device 110 and/or merchant device 120), and/or other devices, transactions may be detected.

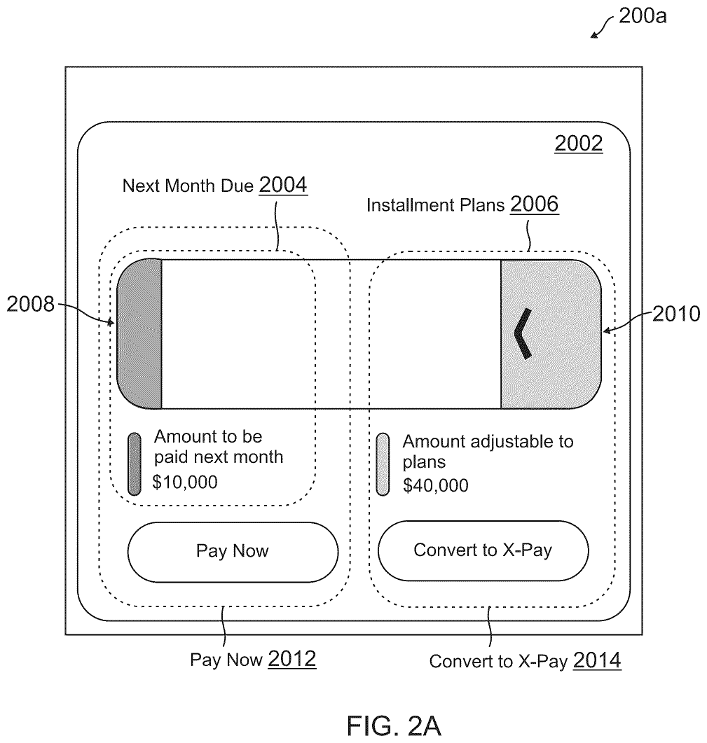

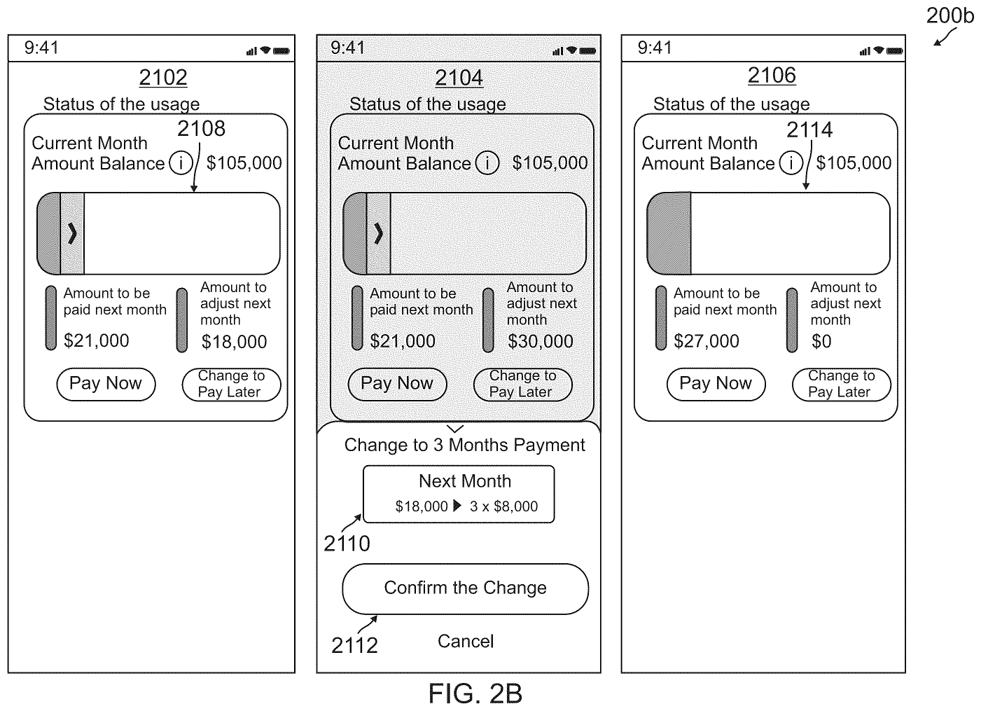

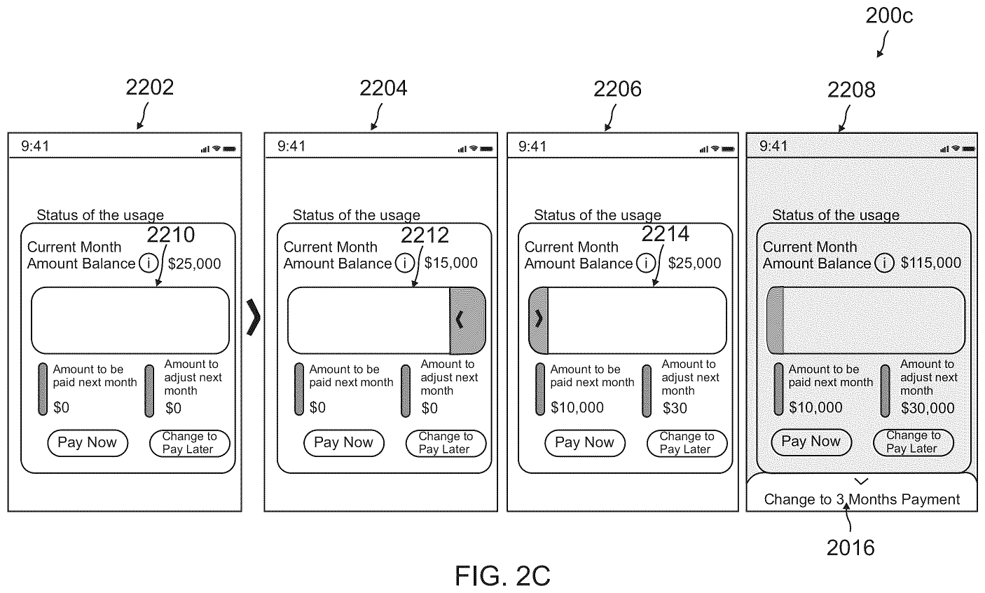

Transaction processing platform 140 may determine whether the transactions comply with the spending limit(s). If so, the transaction may be approved or authorized. However, if the transaction does not comply with the spending limit or exceeds the limit on electronic transaction processing and/or credit/balance limit, then transaction processing platform 140 may be used to decline transaction processing or instruct a backend credit processor and/or merchant device 120 to decline processing of the transaction. Further, transaction processing platform 140 may transmit a message to client device 110 and/or another device to notify the user that the spending limit has been violated and provides an operation to remove or adjust the spending limit, such as through an application icon and/or operations. If the user requests removal or adjustment (and is authenticated in various embodiments), the spending limit may be removed or adjusted by transaction processing platform 140. Examples of such configurations are shown in FIGS. 2A-2C below.

In some embodiments, spending limit identification process 142 may employ one or more AI engines and/or models, such as rules-based, ML, or neural network (NN) models and/or engines, which may be used for intelligent decision-making of spending limits. These may include rules-based engines that may process user data 146 and/or merchant data 148, which may be used to determine spending limits. Further, spending limit identification process 142 may utilize machine learning engines or other AI models or engines to determine spending limitations. Machine learning engines and/or other rule computation or AI engines may be trained and/or used with user data 146 and/or merchant data 126 for determination of spending limits. In some embodiments, machine learning engines may include AI models, such as ML or neural network (NN) models. AI models may generally correspond to any artificial intelligence that performs decision-making, such as rules-based engines and the like. However, AI models may also include subcategories, including ML models and NN models that instead provide intelligent decision-making using algorithmic relationships. Generally, NN may include deep learning models and the like, and may correspond to a subset of ML models that attempt to mimic human thinking by utilizing an assortment of different algorithms to model data through different graphs of neurons, where neurons include nodes of data representations based on the algorithms that may be interconnected with different nodes. ML models may similarly utilize one or more of these mathematical models, and similarly generate layers and connected nodes between layers in a similar manner to neurons of NN models.

When building ML models for machine learning engines, training data may be used to generate one or more classifiers and provide recommendations, predictions, or other outputs based on those classifications and an ML model. The training data may be used to determine input features for training predictive scores and/or outputs for spending limits based on user data 146 and/or merchant data 126, as well as adjust such outputs based on user input for limit adjustment process 144. For example, ML models for machine learning engines may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models for machine learning engines.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models for machine learning engines that attempt to classify and/or provide an output for a predictive spending limit. Thus, when ML models for machine learning engines are used to perform a predictive analysis and output, the input may provide a corresponding output based on the classifications trained for ML models for machine learning engines.

ML models for machine learning engines may be trained by using training data. By providing training data to train ML models for machine learning engines, the nodes in the hidden layer may be trained (adjusted) such that an optimal output (e.g., a classification) is produced in the output layer based on the training data. By continuously providing different sets of training data and penalizing ML models for machine learning engines when the output of ML models for machine learning engines is incorrect, ML models for machine learning engines (and specifically, the representations of the nodes in the hidden layer) may be trained (adjusted) to improve its performance in data classification. Adjusting ML models for machine learning engines may include adjusting the weights associated with each node in the hidden layer. Thus, the training data may be used as input/output data sets that allow for ML models for machine learning engines to make classifications based on input attributes. The output classifications for an ML model trained for machine learning engines may be classifications used for spending limit determination, establishment, and/or adjustment by spending limit identification process 142 and/or limit adjustment process 144. This may include adjust features of such models based on the required and/or identified data points, as well as the desired outputs and decision-making for the ML models. In this regard, MMC, credit limits, user balances, and the like may be used as input for the ML models and trained as features for later user.

Service applications 132 may correspond to one or more processes to execute modules and associated specialized hardware of online transaction processor 130 to process a transaction or provide another service to customers, merchants, and/or other end users and entities of online transaction processor 130. In this regard, service applications 132 may correspond to specialized hardware and/or software used by online transaction processor 130 to providing computing services to users, which may include electronic transaction processing and/or other computing services using accounts provided by online transaction processor 130. In some embodiments, service applications 132 may be used by users, such as a user associated with client device 110, to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by online transaction processor 130. The digital accounts may be accessed and/or used through one or more instances of a web browser application and/or dedicated software application executed by client device 110 and engage in computing services provided by service applications 132. Computing services of service applications 132 may also or instead correspond to messaging, social networking, media posting or sharing, microblogging, data browsing and searching, online shopping, and other services available through online transaction processor 130.

In various embodiments, service applications 132 may be desired in particular embodiments to provide features to online transaction processor 130. For example, service applications 132 may include security applications for implementing server-side security features, programmatic client applications for interfacing with appropriate application programming interfaces (APIs) over network 150, or other types of applications. Service applications 132 may contain software programs, executable by a processor, including a graphical user interface (GUI), configured to provide an interface to the user when accessing online transaction processor 130 via one or more of client device 110, where the user or other users may interact with the GUI to view and communicate information more easily. In various embodiments, service applications 132 may include additional connection and/or communication applications, which may be utilized to communicate information to over network 150.

Additionally, online transaction processor 130 includes database 134. Database 134 may store various identifiers associated with client device 110. Database 134 may also store account data, including payment instruments and authentication credentials, as well as transaction processing histories and data for processed transactions. Database 134 may store received data associated with a user, such as transaction data and spending limits on electronic transaction processing. Further, database 134 may be used to store data for accounts 136, which may be used in calculation of spending limitations.

In various embodiments, online transaction processor 130 includes at least one network interface component 138 adapted to communicate with client device 110, merchant device 120, and/or another device/server for a merchant over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIGS. 2A-C are exemplary diagrams 200a-200c for establishing and adjusting a spending and/or electronic transaction processing limit on a digital account with an online transaction processor, according to an embodiment. Diagrams 200a-200c of FIGS. 2A-C may be displayed by a computing device when setting up and/or adjusting a spending limit via an executable application and/or website, such when interacting with online transaction processor 130 discussed in reference to system 100 of FIG. 1.

In diagram 200a of FIG. 2A, different interactions, inputs, interface elements, and/or communications are shown in order to establish a spending limit on a credit limit available. For example, in an interface 2002 in FIG. 2A, a mobile application interface may allow a user to view the spending limit and adjust a next month due as well as a usage of the spending limit or other monthly power (e.g., monthly spending or funding power) through navigating one or more selectable options. In interface 2002, a spend limit may be adjusted and/or configured using one or more application icons and/or configurable application interactions and inputs. This allows for a spending limit to be set at or lower than a credit limit the user's monthly power in order to better control a user's budget while allowing for the larger credit limit to assist the user in building a better credit score. The user may also request higher credit limits, which may be provided based on outputs from a machine learning engine.

In this regard, interface 2002 includes a next month due selector 2004 (identified as “next month due 2004”) and a x-pay loan conversion selector 2006 (identified as “installment plans 2006”). Next month due selector 2004 may correspond to an available budget of the user that is usable to immediately pay for a transaction via a slidable adjuster 2008. Next month due selector 2004 may be associated with an overall limit of the user's available spending budgets, account balances, or the like, as well as other budgets that may be set by the user, with the corresponding application and/or corresponding service provider for the user's account. X-pay loan conversion selector 2006 may be used to adjust an available amount of monthly credit, which may be extended based on one or more AI engines, such as rules-based and/or ML-based models and/or engines, via a slidable adjuster 2010. A user may then use a slidable bar and/or configurable application feature to select settings of next month due selector 2004 and/or x-pay loan conversion selector 2006 between minimum and maximum amounts. Slidable adjusters 2008 and 2010 may be used by a user to enter input and thereafter set an available amount of money that may be used via a corresponding mobile or other software application, as well as a website, for corresponding spending limits and availability of a user.

After selection of spending limits for next month due selector 2004 and/or x-pay loan conversion selector 2006 via slidable adjusters 2008 and 2010, interface 2002 may display information that allows a user to view a spending limit control panel. For example, in interface 2002 of FIG. 2A, a pay now option 2012 and a loan conversion option 2014 may be displayed that provides information about the spending limit establishment and/or allows confirmation of the spending limits for each of next month due selector 2004 and/or x-pay loan conversion selector 2006 and their corresponding spending limits. Selection of pay now option 2012 and loan conversion option 2014 then allows the user to navigate to further interfaces and/or use the application for the corresponding spending limit. For example, the further interfaces may be used to request further loan agreements and/or credit extensions, as well as provide data on further balances available to the user.

In interfaces 2102, 2104, and 2106 of diagram 200b FIG. 2B, adjustable and configurable slidable bars are shown in order to configure a spending limit for a user via an application interface. For example, in interface 2102, a slidable bar 2108 is shown that includes both an available budget of a user and a loan conversion availability for the user. This may allow the user to configure and/or set multiple different options for a spending limit, which may also be adjusted when a user utilizes or otherwise is provided such options for a spending limit. Thereafter, the user may move the slidable bar to request more of the user's budget, available funds, and/or extendable credit is changed, either to request whether more or less is available via the application providing interfaces 2102, 2104, and/or 2106.

In interface 2104, a confirmation notification and/or request may be provided to the user for confirmation of a corresponding spending limitation that is available via an application and/or website for a digital account usable by the user. This may include providing a confirmation of spending limits 2110 via confirmation option 2112. The confirmation of spending limits 2110 using confirmation option 2112 may result in updating of interfaces 2102 and/or 2104 to interface 2106, which includes an updated spending limit 2114 that allows a user to process transactions electronically using the application and/or website. Thereafter, in FIG. 2C, the user may further configure and/or have adjusted spending limit 2114 based on further preferences, inputs, and/or processed transactions.

In interfaces 2202, 2204, 2206, and 2208 of diagram 200c of FIG. 2C, reduction and/or changes to spending limits are shown. In interface 2202, a user may initially view a monthly power 2210 for the user, which may be based on an available limit or maximum balance, funds, or budget that is extended to and/or established for the user (e.g., based on a risk assessment from information known or available for the user, such as a risk profile or analysis, past payments and repayment history, a bank account balance, a realized and/or expected payment or salary, or other known available value or currency) and an extendable credit to the user. Monthly power 2210 may be used through amounts due next month and amounts converted to x-pay or other installment plan or loan, which each may be configured by moving, entering user input, and/or sliding the interface elements in interface 2202 to show a requested and configured amount due next month and/or amount to convert to an installment plan in interface 2204. In interface 2204, adjusted installment plans 2212 may be shown where less than a maximum of the available credit or monthly power is configured by sliding the interface element left to convert installment plans. Therefore another amount remains available from an extended credit limit for additional installment plans or x-pay. In contrast, with interface 2206, an interface for next month due 2214 is configured by sliding the interface element to the right in order to adjust an available balance and/or spending limit by committing a portion of the monthly power to payments due next month or at the next billing cycle/billing date. Thereafter, confirmation of the spending limits may be confirmed in interface 2208 via a notification 2216.

In various embodiments, the monthly power of the user may reset at the end of the billing or usage cycle and/or beginning of the next billing or usage cycle. This may be a key to having new limits to the user. If existing installment plans still requirement repayment, they may be represented as part of the next month due bar on the left of the interface at the beginning of the billing cycle. The payments may therefore “disappear” or become not individually visible for view and may be incorporated in the installment plans and next month due amount. This allows a user to focus on repayment of a bill and making additional payments without overly utilizing credit or budget and becoming indebted.

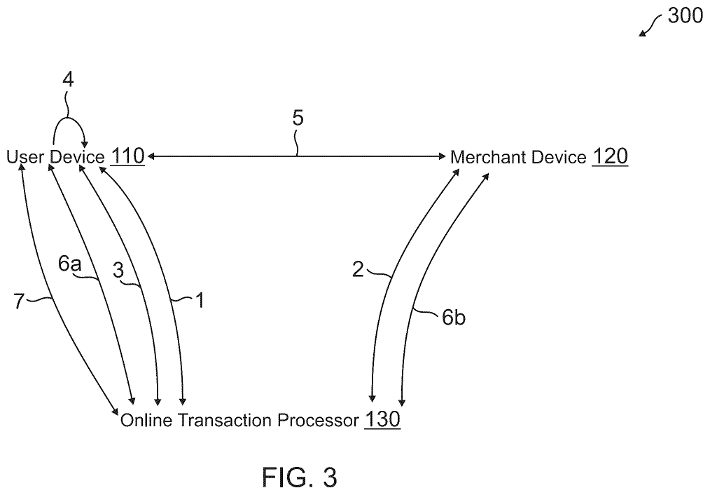

FIG. 3 is an exemplary system environment 300 of interactions between system components for generating and dynamically adjusting application limitations to enforce account usage limitations, according to an embodiment. Environment 300 of FIG. 3 includes client device 110, merchant device 120, and online transaction processor 130 discussed in reference to system 100 of FIG. 1. In this regard, client device 110, merchant device 120, and online transaction processor 130 generate, display, and may be used to configure dynamically rendered or displayed interfaces for device applications, such as purchase application 112, based on available and/or established spending limits.

Environment 300 includes interactions between client device 110, merchant device 120, and online transaction processor 130 that may be used to configure such spending limits and further update such limits. In environment 300, client device 110 may first interact with online transaction processor 130 during interaction 1 in order to request, establish, and/or configure a spending limit. This may be done based on a calculated spending limit for the user associated with client device 110, which may be based on a budget of the user, available balance of the user, income or expected payment to the user, salary of the user, or the like, as well as regulatory or established spending limitations for users in particular regions, countries, or the like. During interaction 1, user data for the user may be acquired and/or determined. At an interaction 2, online transaction processor 130 may interact with merchant device 120 to determine merchant data, as well as any merchant agreements or the like that may be associated with available funds that may be provided by and/or to the merchant corresponding to merchant device 120. This merchant data may be used for determination of a spending limit for the user based on additional merchant data and/or agreements, as well as merchant reliability and/or credit ratings.

At an interaction 3, client device 110 and online transaction processor 130 may interact in order to provide a determined spending limit to a user, which may include a pre-planed budget, available budget or balance, and/or an extendable budget or balance to the user based on one or more AI engines. Such AI engines may include rules-based and/or ML-based engines that configure each of those balances based on user data and/or merchant data for the user associated with client device 110 and the merchant associated with merchant device 120, respectively. A user interface in an application may be configured, updated, and/or output based on the data determined at interaction 3 for the determined spending limit. At an interaction 4, the user may enter input to the application, which may be used to adjust various parameters, features, and/or available limits on the determined spending limits and/or portions of the spending limits (e.g., the available payment amount, credit amount, and/or request for extendable credit). For example, one or more interface elements and/or options may be used to select, scroll through, slide, or adjust interface option to select the available credit.

At an interaction 5, client device 110 interacts with merchant device 120, such as to process a transaction and/or otherwise engage in a use of the configured spending balance. For example, client device 110 may engage in electronic transaction processing for a transaction with merchant device 120 based on the configured spending limit and using the application on client device 110 or another available website or the like via a browser application. In response to interaction 5, online transaction processor 130 may interact with client device 110 and merchant device 120 during interactions 6a and 6b to approve and/or confirm the transaction processing. This may include confirming the available user data, user configurations of the spending limit, merchant data, merchant agreements, and the like prior to payment confirmation. Thereafter, at an interaction 7, online transaction processor 130 may dynamically adjust the available spending limit and/or interface element and show a remaining balance or availability of the spending limit in the application on client device 110. Further, there may be an option for credit reset and/or adjustment after an initial offer and/or usage of credit. This may be based on updated user and/or merchant data processed by one or more ML engines.

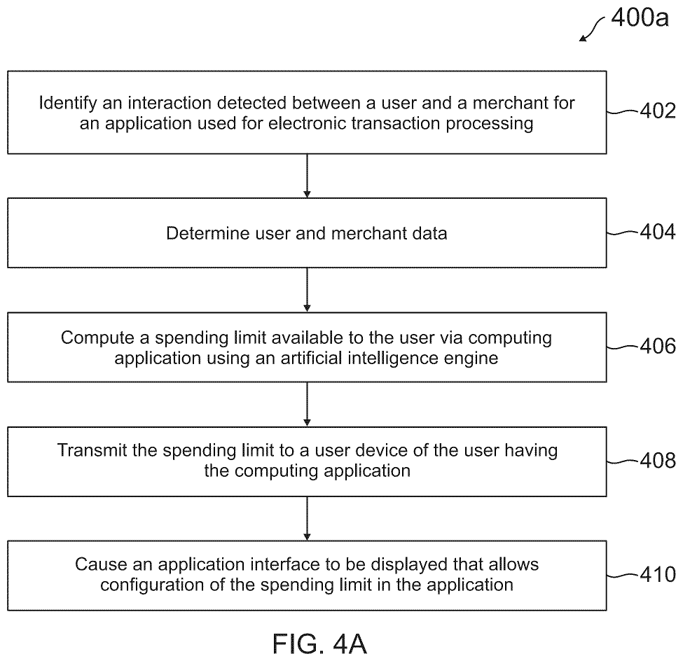

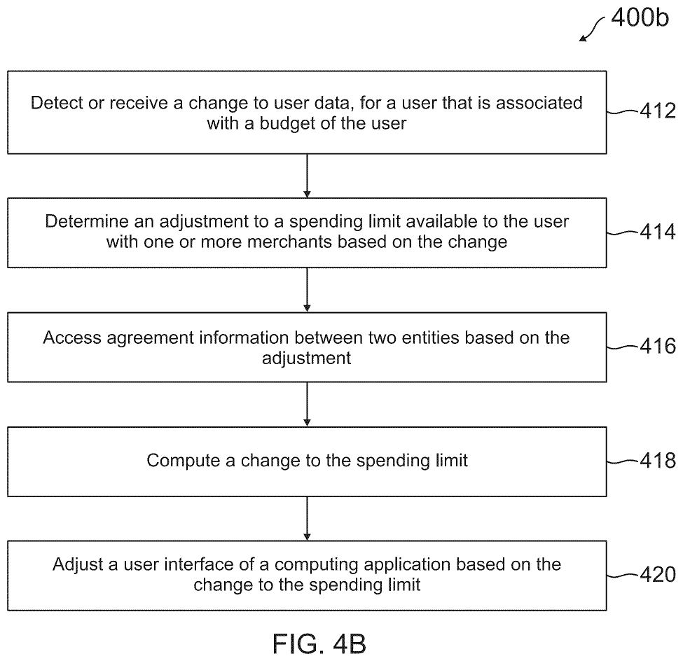

FIG. 4A is a flowchart 400a of an exemplary process for generating application limitations to enforce account usage limitations, according to an embodiment. Note that one or more steps, processes, and methods described herein of flowchart 400a may be omitted, performed in a different sequence, or combined as desired or appropriate.

At step 402 of flowchart 400a, an interaction detected between a user and a merchant for an application used for electronic transaction processing is identified. The interaction may correspond to a user requesting an available balance that may be used with the merchant and/or one or more other merchants. Such request may be based on an available balance to the user (e.g., in a bank account or via another financial account or instrument including periodic salaries or pay periods), as well as credit or other limits that may be extended to the user.

At step 404, user data and merchant data are determined. The user data may include user financial data, historical payment and/or repayment data, credit worthiness, and the like. The merchant data may include merchant agreements for extendable credit levels, merchant balances and/or credit worthiness, and the like. Such data may be accessed from one or more data repositories, computing devices, and/or the like for the user and the merchant associated with such data.

At step 406, a spending limit available to the user via a computing application is computed or determined, such as by using an AI engine. The AI engine may include one or more rules-based and/or ML-based models for the engine, which may provide predictive output and determination of available balances, upcoming balances, and/or credit limits that may be available to the user. Using the user data and the merchant data, such availability of a spending limit may be calculated, which may also include sectioning of the available data into multiple categories, such as a spending limit of available and/or credit funds, as well as a conversion of funds to a certain amount of credit or extended payment plans.

At step 408, the spending limit is transmitted to a user device, such as a computing and/or mobile device having the computing application. The spending limit may be updated in the computing application such that the user may view one or more interface elements, options, icons, and/or user input preferences for adjusting the spending limit. This may include one or more scrollable bars or user inputs that allow for configuration of the spending limit. Transmission of the spending limit may occur prior to loading of the application and/or in a proactive manner so that the user may view the spending limit immediately and/or upon loading of the computing application. Thus, at step 410, an application interface is caused to be displayed that allows for configuration of the spending limit in the application. This may be done via user input to the computing application via the user interface elements displayed for the spending limit and may allow for separate configuration of different parameters and/or balances (e.g., available or monthly balance limit, extendable credit, etc.).

FIG. 4B is a flowchart 400b of an exemplary process for dynamically adjusting application limitations to enforce account usage limitations, according to an embodiment. Note that one or more steps, processes, and methods described herein of flowchart 400b may be omitted, performed in a different sequence, or combined as desired or appropriate.

At step 412 of flowchart 400b, a change to user data for a user that is associated with a budget of the user is detected and/or received. For example, the user may utilize a portion of a budget and/or extended credit to perform a purchase. This may be done through a computing application, which may extend electronic transaction processing services to the user. The change may also be based on other user data, such as changes in available balances, income or other incoming funds for the user, and/or other outgoing payments by the user.

At step 414, an adjustment to a spending limit available to the user with one or more merchants is determined based on the change. The adjustment may be calculated, such as based on an AI engine (e.g., a rules-based or ML-based model engine that may utilize the change and user/merchant data in order to provide a predictive output). The adjustment may include otherwise changing the available spending limit to the user via a user interface of the user. Thus, the adjustment may include one or more configurable settings for the spending limit of the user that may automatically adjust the spending limit from a previously available limit.

At step 416, agreement information between two entities is accessed based on the adjustment. The agreement information may include one or more merchant or other entity agreements and/or requirements for credit extension available to one or more of the entities, which may be used to determine a level of availability of the spending limit to the user. At step 418, a change to the spending limit is computed, such as using an AI engine that may include one or more rules or ML-based models. These engines may be used to make intelligent decision-making of the available spending limit to the user in a dynamic manner. Thus, dynamically, the spending limit may be adjusted based on changes to the user information, agreement information, merchant information, or the like, as well as spending patterns and/or user input. At step 420, a user interface of a computing application is adjusted based on the change to the spending limit. The user interface may be dynamically adjusted and/or changed based on the change to the spending limit in a proactive and/or dynamic manner so that the user may immediately view the change in the application in real-time and/or when loading and executing the application. Thus, when the user views the user interface, the user may immediately or in near real-time, see the changes to the spending limit.

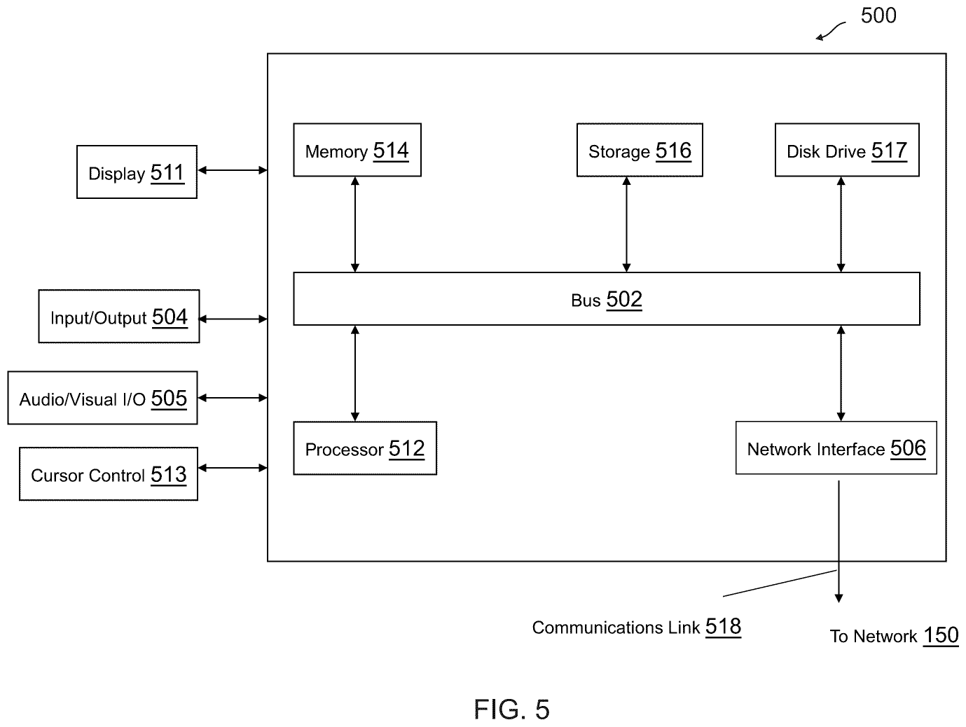

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
detecting an interaction between a user and a merchant using an application on a user device of the user;
determining user data for the user and merchant data for the merchant;
executing a rules-based engine of the system that is associated with the application;
computing a spending limit available to the user with the merchant based on the user data and the merchant data based on the executed rules-based engine;
transmitting, to the user device of the user, the spending limit through an application programming interface (API) of an application on the user device;
automatically updating data, via the API with the spending limit, for an interface on the user device; and
implementing an adjustable option with the system for the spending limit in the interface.

2. The system of claim 1, wherein the operations further comprise:
receiving an electronic transaction processing request for a transaction;
determining that a transaction violates the spending limit; and
rejecting, via the API, the electronic transaction processing request via the interface.

3. The system of claim 1, wherein the operations further comprise:
transmitting a notification to the user device, wherein the notification comprises an option to adjust the spending limit and utilize less than a maximum amount of the spending limit utilizing the adjustable option;
in response to the transmitting the notification, receiving a request to adjust the spending limit via the adjustable option; and
adjusting the spending limit available via the application using the API.

4. The system of claim 3, wherein the option requires an authentication for a digital account required by the user.

5. The system of claim 1, wherein the computing the spending limit comprises precomputing a plurality of states of the application that are loaded to the application via the transmitting prior to an activation of the application on the user device.

6. The system of claim 1, wherein the spending limit is set for a time period associated with a usage of the maximum credit amount, and wherein the spending limit is at or below a maximum credit amount limit available to the user with the merchant during the time period.

7. The system of claim 1, wherein the spending limit further comprises a transaction type limit based on one or more merchant category codes (MCCs) for the merchant.

8. The system of claim 1, wherein prior to the computing the spending limit, the operations further comprise:
determining a merchant authorized spending agreement with the merchant,
wherein the spending limit is further computed based on the merchant authorized spending agreement.

9. The system of claim 1, wherein the automatically updating comprises rendering, in the interface, a dynamic spending limitation graphical element for the adjustable option that identifies the spending limit precomputed prior to the rendering to the user on the user device.

10. The system of claim 1, wherein the operations further comprise:
flattening an available balance in the interface on the user device;
hiding one or more conversion options in the interface; and
creating an animation or a graph for the flattened available balance in the interface.

11. A method comprising:
determining, by an online transaction processor, a first spending plan associated with a merchant and a user based, at least on, a budget of the user;
generating interface data and an application limitation for an application on a user device of the user based on the budget of the user;
implementing a computing platform of the online transaction processor associated that is associated with the application;
setting, with the application via the computing platform, the interface data for presentation to the user in response to detecting the user viewing a request to process a transaction with the merchant; and
enforcing, by the online transaction processor during application interactions by the user in the application, the application limitation via the interface data for the based on the setting.

12. The method of claim 11, further comprising:
receiving a second spending plan that requests to adjust the first spending plan above or below the budget for the user; and
adjusting the first spending plan based on the second spending plan.

13. The method of claim 11, wherein a maximum amount available for the first spending plan comprises a credit limit established for the user based on at least one of the budget or a regulatory threshold amount associated with the merchant.

14. The method of claim 11, wherein the first spending plan is determined and set with the interface data prior to a loading of the application on the user device.

15. The method of claim 11, wherein the setting the interface data comprises adjusting a spending animation availability for the first spending limit with the interface for a purchase interface associated with the merchant.

16. A non-transitory machine-readable medium having stored thereon machine-readable instructions executable to cause a machine to perform operations comprising:
causing to be displayed, via a user interface in an application on a device of a user via an application programming interface (API) of the application, at least one interface element associated with a spending limit on a credit extension to the user, wherein the credit extension has a maximum credit amount linked to at least one merchant that is provided to the user;
determining an update to the spending limit for the application utilizing a rules-based computing engine;
establishing, via the user interface through the API, the updated spending limit for the credit extension with the user in the application; and
monitoring the application for usage of the updated spending limit via the API.

17. The non-transitory machine-readable medium of claim 16, wherein the rules-based computing engine further comprises at least one machine learning (ML) model trained for updating a plurality of spending limits utilized by the application.

18. The non-transitory machine-readable medium of claim 17, wherein the at least one ML model provides a dynamic version of the updated spending limit based on a set of ML features.

19. The non-transitory machine-readable medium of claim 16, wherein the operations further comprise:
detecting a usage of at least a portion of the updated spending limit; and
further establishing a revised spending limit based on the usage via the user interface.

20. The non-transitory machine-readable medium of claim 16, wherein prior to determining the update, the operations further comprise:
identifying at least one spending agreement with the at least one merchant for the credit extension,
wherein determining the update is further based on the at least one identified spending agreement.
